(19) United States
(12) Patent Application Publication
(10) Pub. No.: US 2021/0197322 A1
(43) Pub. Date: Jul. 1, 2021

(54) METHOD FOR COUPLING A WIRE TO CONDUCTIVE FABRIC WITH LOW-TEMPERATURE SOLDER

(71) Applicant: Joyson Safety Systems Acquisition LLC, Auburn Hills, MI (US)

(72) Inventor: Dwayne Van'tZelfde, Holly, MI (US)

(21) Appl. No.: 17/129,229

(22) Filed: Dec. 21, 2020

Related U.S. Application Data
(60) Provisional application No. 62/955,797, filed on Dec. 31, 2019.

(51) Int. Cl. B23K 35/26; B23K 35/02; B23K 1/00

(52) U.S. Cl. CPC B23K 35/264; B23K 1/0008; B23K 35/0227

(57) ABSTRACT

Various implementations include a method of coupling a wire to conductive fabric. The method includes providing a conductive fabric, placing low-temperature solder in contact with a portion of the conductive fabric wherein the low-temperature solder has a liquidus temperature and a solidus temperature, placing a wire in contact with the low-temperature solder, increasing the temperature of the low-temperature solder to the liquidus temperature, and decreasing the temperature of the low-temperature solder to the solidus temperature. In some implementations, the low-temperature solder has a preformed shape corresponding to a surface of a portion of a wire, and the surface of the wire is placed in contact with the low-temperature solder.

### CROSS-REFERENCE TO RELATED APPLICATIONS

This application claims the benefit of U.S. Provisional Patent Application No. 62/955,797, filed Dec. 31, 2019, the contents of which are incorporated herein by reference in their entirety.

### BACKGROUND

Current methods for electrically coupling a wire to conductive fabric include soldering the wire to the fabric using standard tin or tin-lead solder. Although this method provides for an adequate mechanical connection, the reflow temperature of standard solder can be as high as 240°−250° C., which is much higher than the failure temperature of many conductive fabrics.

To avoid damaging the conductive fabric during soldering, the soldering is a complex process, including quickly heating the solder to its reflow temperature and then cooling the solder before the conductive fabric can reach a damaging temperature. Although standard tin and tin-lead solder is relatively cheap, this process can be unreliable, and the expenses of controlling the process outweigh the material costs.

Other methods of electrically coupling a wire to conductive fabric include a crimp-based connection. In this method, the wire and conductive fabric are crimped together. While this method is cost-effective, crimp-based connections are both electrically and mechanically unreliable, and the crimping process can damage the conductive fabric.

Other current methods include coupling a wire to conductive fabric using a conductive adhesive. Although the conductive adhesive does not create a risk of damaging the conductive fabric, the conductive adhesive has a long cure time, which makes this method infeasible in some applications.

Thus, there is a need for a method of electrically coupling a wire to conductive fabric that provides for a reliable electrical and mechanical connection that is cost effective.

### SUMMARY

Various implementations include a method of coupling a wire to conductive fabric. The method includes (1) providing a conductive fabric; placing low-temperature solder in contact with a portion of the conductive fabric, wherein the low-temperature solder has a liquidus temperature and a solidus temperature; (3) placing a wire in contact with the low-temperature solder; (4) increasing the temperature of the low-temperature solder to the liquidus temperature; and (5) decreasing the temperature of the low-temperature solder to the solidus temperature.

In some implementations, the low-temperature solder includes bismuth. In some implementations, the low-temperature solder includes 50% bismuth or more by mass. In some implementations, the low-temperature solder includes 57% bismuth, 42% tin, and 1% silver by mass.

In some implementations, the liquidus temperature of the low-temperature solder is 170° C. or lower. In some implementations, the liquidus temperature of the low-temperature solder is 140° C. or lower.

In some implementations, the conductive fabric includes silver plated, knitted nylon mesh.

In some implementations, the method further includes preheating the low-temperature solder before placing the low-temperature solder in contact with a portion of the conductive fabric, preheating the wire before placing the wire in contact with the low-temperature solder, or both.

In some implementations, the wire includes a terminal and the terminal is placed in contact with the low-temperature solder. In some implementations, the terminal is a spade terminal, fork terminal, or ring terminal.

Various other implementations include a method of coupling a wire to conductive fabric. The method includes (1) providing a conductive fabric; (2) placing low-temperature solder in contact with a portion of the conductive fabric, wherein the low-temperature solder has a preformed shape corresponding to a surface of a portion of a wire, wherein the low-temperature solder has a liquidus temperature and a solidus temperature; (3) placing the surface of the wire in contact with the low-temperature solder; (4) increasing the temperature of the low-temperature solder to the liquidus temperature; and (5) decreasing the temperature of the low-temperature solder to the solidus temperature.

In some implementations, the low-temperature solder includes bismuth. In some implementations, the low-temperature solder includes 50% bismuth or more by mass. In some implementations, the low-temperature solder includes 57% bismuth, 42% tin, and 1% silver by mass.

In some implementations, the liquidus temperature of the low-temperature solder is 170° C. or lower. In some implementations, the liquidus temperature of the low-temperature solder is 140° C. or lower.

In some implementations, the conductive fabric includes silver plated, knitted nylon mesh.

In some implementations, the method further includes preheating the low-temperature solder before placing the low-temperature solder in contact with a portion of the conductive fabric, preheating the wire before placing the wire in contact with the low-temperature solder, or both.

In some implementations, the wire includes a terminal and the terminal is placed in contact with the low-temperature solder. In some implementations, In some implementations, the terminal is a spade terminal, fork terminal, or ring terminal. In some implementations, the preformed shape of the low-temperature solder corresponds to a surface of a portion of the terminal of the wire.

In some implementations, the preformed shape of the low-temperature solder has a plan view surface. The shape of the plan view surface is a circle, oval, square, or rectangle.

### BRIEF DESCRIPTION OF DRAWINGS

Example features and implementations are disclosed in the accompanying drawings. However, the present disclosure is not limited to the precise arrangements and instrumentalities shown. Similar elements in different implementations are designated using the same reference numerals.

FIGS. 1-4 show top views of a method of coupling wire to conductive fabric, in accordance with one implementation.

FIG. 5 shows a top view of a spade terminal coupled to a wire, in accordance with some implementations.

FIG. 6 shows a top view of a fork terminal coupled to a wire, in accordance with some implementations.

FIG. 7 shows a top view of a ring terminal coupled to a wire, in accordance with some implementations.

### DETAILED DESCRIPTION

Various implementations of the methods disclosed herein provide for an economic process of electrically and mechanically coupling a wire to conductive fabric using low-temperature solder. Although low-temperature solder is more expensive than standard tin or tin-lead solder (e.g., 10-15 times more expensive), various implementations of the methods disclosed herein are less susceptible to damaging the conductive fabric than processes using standard solder. The likelihood of damaging the conductive fabric with high heat is much lower when using low-temperature solder, which allows for reduced complexity in the soldering process, resulting in lower assembly costs. Various implementations of the methods disclosed herein also provide for using preformed low-temperature solder to electrically and mechanically couple a wire to conductive fabric. Using preformed low-temperature solder allows for better control of the amount of solder being used and reduces assembly time.

Various implementations include a method of coupling a wire to conductive fabric. The method includes providing a conductive fabric, placing low-temperature solder in contact with a portion of the conductive fabric wherein the low-temperature solder has a liquidus temperature and a solidus temperature, placing a wire in contact with the low-temperature solder, increasing the temperature of the low-temperature solder to the liquidus temperature, and decreasing the temperature of the low-temperature solder to the solidus temperature.

In some implementations, the low-temperature solder has a preformed shape corresponding to a surface of a portion of a wire, and the surface of the wire is placed in contact with the low-temperature solder.

Low-temperature solder refers to solder that has a liquidus temperature that is lower than the temperature at which the conductive fabric to which the solder is being coupled would be damaged. In addition, conductive fabric refers to any fabric through which electricity can be conducted. Examples of low-temperature solder and conductive fabrics are described below.

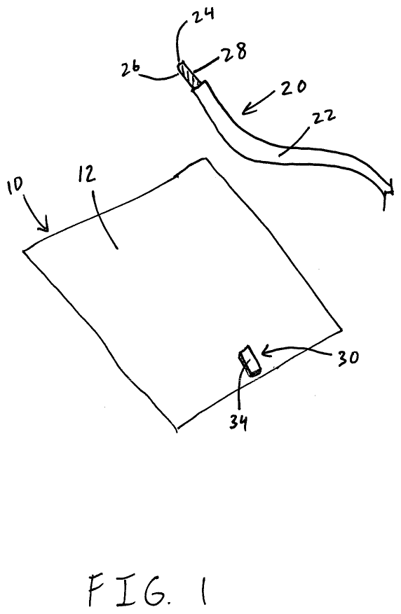

FIGS. 1-4 shows a method of coupling a wire 20 to a conductive fabric 10 using a preformed low-temperature solder 30. FIGS. 1-4 show a conductive fabric 10, a wire 20, and a preformed low-temperature solder 30. The conductive fabric 10 has a surface 12 to which the wire 20 can be coupled. The conductive fabric 10 shown in FIGS. 1-4 is a silver plated, knitted nylon mesh, but in other implementations, the conductive fabric is any other type of conductive fabric, such as nickel-plated conductive fabric.

The wire 20 shown in FIGS. 1-4 is a concentric stranded copper wire with the insulation 22 removed from an end 24 of the wire 20 such that a portion of the wire 20 adjacent the end 24 of the wire 20 is an exposed portion 28. However, in other implementations, the wire is a solid core, prefused, braided, bunch strand, rope strand, sector strand, segmental strand, annular strand, compact strand, compressed strand, or any other type of wire. The wire 20 shown in FIGS. 1-4 is copper, but in other implementations, the wire is any other material capable of conducting electricity.

The low-temperature solder 30 has a preformed shape having a plan view surface 34. The plan view surface 34 of the solder 30 has a plan view shape that corresponds to a plan view shape of a surface 26 of the exposed portion 28 of the wire 20. For example, the plan view surface 34 of the preformed low-temperature solder 30 shown in FIGS. 1-4 has a rectangular plan view shape that corresponds to the rectangular plan view shape of the exposed portion 28 of the wire 20.

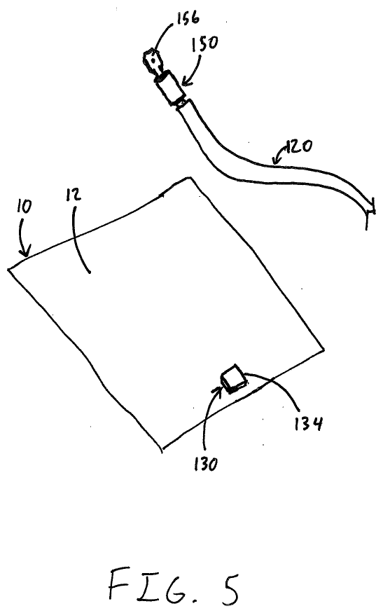

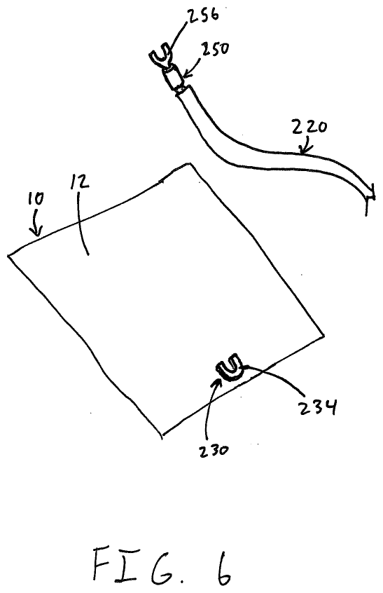

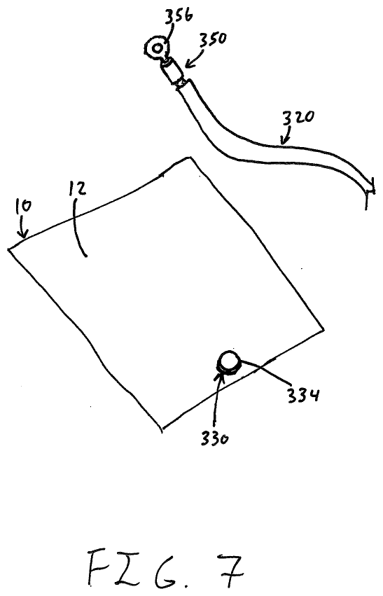

In other implementations, the wire includes a terminal coupled to the end of the exposed portion of the wire. FIGS. 5-7 shows examples of various types of terminals 150, 250, 350 coupled to a wire 120, 220, 320. FIG. 5 shows a spade terminal 150 coupled to a wire 120. FIG. 6 shows a fork terminal 250 coupled to a wire 220. And, FIG. 7 shows a ring terminal 350 coupled to a wire 320.

In FIGS. 5-7, each of the terminals 150, 250, 350 has a surface 156, 256, 356, respectively, and the shape of the plan view surfaces 134, 234, 334 of the preformed low-temperature solder 130, 230, 330 corresponds to the plan view shape of the surface 156, 256, 356 of the terminal 150, 250, 350, respectively. In particular, the plan view surface 156 of the spade terminal 150 shown in FIG. 5 has a rectangular shape, and the plan view surface 134 of the preformed low-temperature solder 130 has a rectangular shape. The plan view surface 256 of the fork terminal 250 shown in FIG. 6 has a pronged, U-shape, and the plan view surface 234 of the preformed low-temperature solder 230 has a pronged, U-shape. The plan view surface 356 of the spade terminal 350 shown in FIG. 7 has a circular shape, and the plan view surface 334 of the preformed low-temperature solder 330 has a circular shape. In other implementations, the plan view surface of the preformed low-temperature solder can have any shape that corresponds to a plan view surface of the wire or terminal of the wire, such as a circle, oval, square, or rectangle.

Although FIGS. 1-7 show the use of preformed low-temperature solder 30, 130, 230, 330, in other implementations, the low-temperature solder is not preformed. In such implementations, the amount of low-temperature solder to be used for the disclosed soldering methods is selected based on the size and shape of the wire or wire terminal to be coupled to the conductive fabric. The low-temperature solder can be in the form of a meltable wire or a paste. In some implementations, the preformed or unformed low-temperature solder can also include flux.

The preformed low-temperature solder 30, 130, 230, 330 shown in FIGS. 1-7 includes 57% bismuth, 42% tin, and 1% silver by mass. The low-temperature solder 30, 130, 230, 330 has a liquidus temperature of 140° C. and a solidus temperature of 139° C. In other implementations, any low-temperature solder can be used having a liquidus temperature that is below the maximum temperature that the conductive fabric can withstand without being damaged. For example, in some implementations, the low-temperature solder selected has a liquidus temperature of below 170° C., which is the maximum temperature the silver plated, knitted nylon mesh conductive fabric can withstand without being damaged. In other implementations, the low-temperature solder is any low-temperature solder including at least 50% bismuth. In other implementations, the low-temperature solder does not include bismuth, and the low-temperature solder includes indium or a tin-lead alloy with a low amount of silver having a liquidus temperature below the maximum withstandable temperature of the conductive fabric. In some implementations, the low temperature solder contains two or more of the following elements: 3.5% to 67.0% by weight bismuth, 1.0% to 86.5% by weight tin, 1.0% to 70.0% by weight lead, 0.4% to 10.0% by weight silver, 4.0% by weight mercury, 0.5% to 40.0% by weight cadmium, 1.8% to 7.6% by weight zinc, 1.0% to 100.0% by weight indium, and/or 1.1% to 9.0% by weight antimony. In some implementations, the low-temperature solder can include a dopant selected from 0.05% by weight silver, 0.06% to 0.16% by weight copper, and/or 0.25% by weight cadmium. In some implementations, the low-temperature solder can have a liquidus temperature of from 43° C. to 289° C. and a solidus temperature of from 38° C. to 181° C.

In some implementations, the preformed solder has plan view dimensions of 0.2 inches by 0.2 inches and a thickness of 0.009 inches. In some implementations, the preformed low-temperature solder has a mass of 0.1 grams or less. In some implementations, the preformed low-temperature solder has a mass of 0.05 grams or less.

To couple the wire 20, or the terminal 150, 250, 350, to the conductive fabric 10, a preformed low-temperature solder 30, 130, 230, 330 is placed on a surface 12 of the conductive fabric 10, as shown in FIG. 1. The preformed low-temperature solder 30, 130, 230, 330 can be optionally preheated prior to placing the preformed low-temperature solder 30, 130, 230, 330 on the surface 12 of the conductive fabric 10 to reduce the time and heat energy needed to increase the temperature of the solder 30, 130, 230, 330 to its liquidus temperature, as discussed below.

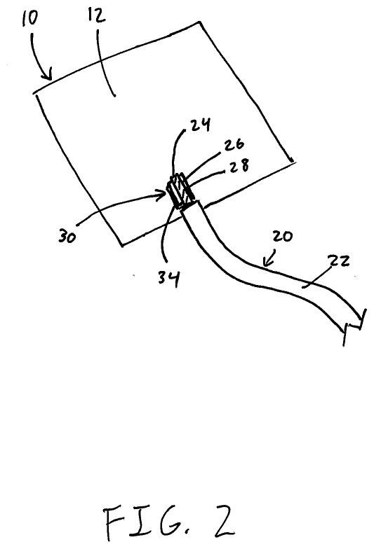

The exposed portion 28 of the wire 20, or the terminal 150, 250, 350, is then placed on the low-temperature solder 30, 130, 230, 330 such that the surface 26 of the wire 20, or the surface 156, 256, 356 of the terminal 150, 250, 350, abuts the low-temperature solder 30, 130, 230, 330, as shown in FIG. 2. The surface 26, 156, 256, 356 directly contacts the solder 30, 130, 230, 330, respectively. Similar to the preformed low-temperature solder 30, 130, 230, 330, the surface 26 of the exposed portion 28 of the wire 20, or the surface 156, 256, 356 of the terminal 150, 250, 350, respectively, can also optionally be preheated prior to placing the surface 26, 156, 256, 356 on the preformed low-temperature solder 30, 130, 230, 330 to reduce the time and heat energy needed to increase the temperature of the solder 30, 130, 230, 330 to its liquidus temperature.

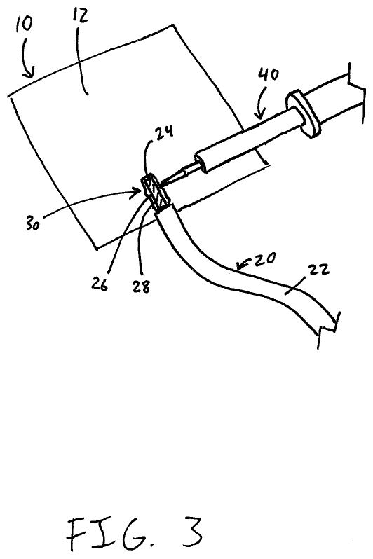

A soldering iron 40 is then placed in contact with the low-temperature solder 30, 130, 230, 330 and/or the surface 26 of the exposed portion 28 of the wire 20, or the surface 156, 256, 356 of the terminal 150, 250, 350, to increase the temperature of the low-temperature solder 30, 130, 230, 330 above the liquidus temperature, as shown in FIG. 3. Although FIG. 3 shows a soldering iron 40 being used to increase the temperature of the low-temperature solder 30, 130, 230, 330, in other implementations, the temperature of the low-temperature solder is increased by a hot air tool, a hot bar, an oven, or any other source of heat capable of increasing the temperature of the low-temperature solder to the liquidus temperature without damaging the conductive fabric. In some implementations, the soldering iron can be used to apply pressure to the low-temperature solder and/or the surface of the wire or terminal during heating to displace the low-temperature solder as the low-temperature solder liquifies. The displacement of the liquid low-temperature solder causes the low-temperature solder to encapsulate a portion of the conductive fabric and the wire or terminal to increase the contact between the conductive fabric and the wire or terminal. In some implementations, the pressure is applied to the low-temperature solder and/or the surface of the wire or terminal by separate tool or by hand prior to or during the soldering process.

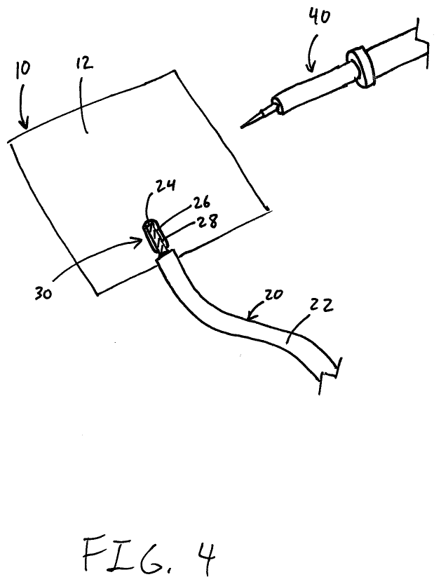

Once the low-temperature solder 30, 130, 230, 330 reaches its liquidus temperature, the low-temperature solder 30, 130, 230, 330 begins to reflow. The soldering iron 40, or other heat source, is then removed to allow the temperature of the low-temperature solder 30, 130, 230, 330 to decrease below its solidus temperature, as shown in FIG. 4. After the low-temperature solder 30, 130, 230, 330 reaches its solidus temperature, the wire 20, or terminal 150, 250, 350, is mechanically and electrically coupled to the surface 12 of the conductive fabric 10.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

What is claimed is:

1. A method of coupling a wire to conductive fabric, the method comprising:
providing a conductive fabric;
placing low-temperature solder in contact with a portion of the conductive fabric, wherein the low-temperature solder has a liquidus temperature and a solidus temperature;
placing a wire in contact with the low-temperature solder;
increasing the temperature of the low-temperature solder to the liquidus temperature; and
decreasing the temperature of the low-temperature solder to the solidus temperature.

2. The method of claim 1, wherein the low-temperature solder comprises bismuth.

3. The method of claim 2, wherein the low-temperature solder comprises 50% bismuth or more by mass.

4. The method of claim 3, wherein the low-temperature solder comprises 57% bismuth, 42% tin, and 1% silver by mass.

5. The method of claim 1, wherein the liquidus temperature of the low-temperature solder is 170° C. or lower.

6. The method of claim 5, wherein the liquidus temperature of the low-temperature solder is 140° C. or lower.

7. The method of claim 1, wherein the conductive fabric comprises silver plated, knitted nylon mesh.

8. The method of claim 1, further comprising preheating the low-temperature solder before placing the low-temperature solder in contact with a portion of the conductive fabric, preheating the wire before placing the wire in contact with the low-temperature solder, or both.

9. The method of claim 1, wherein the wire comprises a terminal and the terminal is placed in contact with the low-temperature solder.

10. The method of claim 9, wherein the terminal is a spade terminal, fork terminal, or ring terminal.

11. A method of coupling a wire to conductive fabric, the method comprising:
providing a conductive fabric;
placing low-temperature solder in contact with a portion of the conductive fabric, wherein the low-temperature solder has a preformed shape corresponding to a surface of a portion of a wire, wherein the low-temperature solder has a liquidus temperature and a solidus temperature;
placing the surface of the wire in contact with the low-temperature solder;
increasing the temperature of the low-temperature solder to the liquidus temperature; and
decreasing the temperature of the low-temperature solder to the solidus temperature.

12. The method of claim 11, wherein the low-temperature solder comprises bismuth.

13. The method of claim 12, wherein the low-temperature solder comprises 50% bismuth or more by mass.

14. The method of claim 13, wherein the low-temperature solder comprises 57% bismuth, 42% tin, and 1% silver by mass.

15. The method of claim 11, wherein the liquidus temperature of the low-temperature solder is 170° C. or lower.

16. The method of claim 15, wherein the liquidus temperature of the low-temperature solder is 140° C. or lower.

17. The method of claim 11, wherein the conductive fabric comprises silver plated, knitted nylon mesh.

18. The method of claim 11, further comprising preheating the low-temperature solder before placing the low-temperature solder in contact with a portion of the conductive fabric, preheating the wire before placing the wire in contact with the low-temperature solder, or both.

19. The method of claim 11, wherein the wire comprises a terminal and the terminal is placed in contact with the low-temperature solder.

20. The method of claim 19, wherein the terminal is a spade terminal, fork terminal, or ring terminal.

21. The method of claim 19, wherein the preformed shape of the low-temperature solder corresponds to a surface of a portion of the terminal of the wire.

22. The method of claim 11, wherein the preformed shape of the low-temperature solder has a plan view surface, the shape of the plan view surface being a circle, oval, square, or rectangle.
